(19) United States
(12) Patent Application Publication
(10) Pub. No.: US 2016/0332382 A1
(43) Pub. Date: Nov. 17, 2016

(54) 3D Printing of Facial Prostheses

(71) Applicants: KING'S COLLEGE LONDON, London (GB); THE BOARD OF REGENTS FOR OKLAHOMA STATE UNIVERSITY, Stillwater, OK (US); TECHNOVENT LIMITED, Bridgend (GB)

(72) Inventors: Trevor Coward, London (GB); Swati Jindal, London (GB); Mark Waters, Newport (GB); James Smay, Stillwater, OK (US)

(21) Appl. No.: 15/111,444

(22) PCT Filed: Jan. 13, 2015
(86) PCT No.: PCT/GB2015/050056

§ 371 Date: Jul. 13, 2016

Related U.S. Application Data
(60) Provisional application No. 61/927,025, filed on Jan. 14, 2014.
(60) Provisional application No. 62/071,054, filed on Sep. 12, 2014.

(51) Int. Cl. B29C 67/00; B33Y 10/00; B33Y 30/00

(52) U.S. Cl. CPC B29C 67/0088; B29C 67/0062; B33Y 30/00; B33Y 10/00; B29K 2083/005

(57) ABSTRACT

Firstly, a custom designed 3D printer with x-y-z gantry robot with an accuracy of 0.1 μm was adapted with a custom designed printing head (51b). Secondly, a two component silicone elastomer suitable for RP was developed that incorporates the desired characteristics and properties similar to those commercially available for the provision of facial and body prostheses. The silicone elastomer is composed of polydimethylsiloxane (PDMS) chains, filler, catalyst and crosslinker. By varying the amount of these components the mechanical properties of the silicone elastomer can be altered, for example, tensile strength, tear strength, hardness and wettability. To achieve these desired properties consideration must also be given to the set time and viscosity of the silicone elastomer and additionally the speed at which the material is printed.

### INTRODUCTION

The present invention relates to 3D printing of a bio-compatible two component silicone material for anatomical prostheses. In particular, the present invention relates to a multi-component mixer nozzle of a 3D printer for the printing of silicone anatomical prostheses.

### BACKGROUND AND PRIOR ART

Maxillofacial prostheses are often required for patients who have lost facial or body parts, for example, an ear, a nose, an eye, or the like. These defects can result, for example, from trauma, congenital malformations or disease. Currently, the majority of facial prostheses are manufactured by hand carving the missing defect in wax, and creating a two-part mould into which pigmented silicone elastomer is placed. There are also a few craniofacial centres that produce the anatomical face or body part by utilising computerised tomography (CT) data in conjunction with rapid prototyping (RP) which is either made into a hard resin plastic or a hard thermoformed wax. However, these methods still require a mould into which a bio-compatible pigmented silicone elastomer is placed [1]-[6].

Such methods of prostheses construction typically involve five to six patient visits and can be very time consuming. In addition, this process involves the use of a highly skilled maxillofacial prosthetist and the resulting success depends upon the individuals colour perception and interpretation skills. Although excellent results can be obtained, they are not easily reproduced and depend very much on the prosthetist's artistic skills.

Sheffield University collaborated with a design company called Fripp Design Ltd to use a powder binder approach using a Z Corp 3D printer, wherein the 3D model was manufactured from digital data on a 3D colour printer using starch powder, which is a 100% bio-compatible material. Once the anatomical part has been printed out, it may be the right shape but also very brittle, and so to soften and strengthen the printed object the anatomical part is soaked in a very low viscosity, medical grade silicone fluid. A computer programme was also created to adjust the colour of the printed part so that the final product matches the patient's skin tone. Other approaches, such as that of Van Noort [7], do not involve direct printing of silicone. As far as it is known, there appears to be no known research directed towards direct printing of bio-compatible two component silicones for facial or body prostheses.

The present invention addresses the above noted problems by making the process of manufacturing facial and body prostheses more reproducible, reducing the number of appointments needed to provide a patient with a prostheses and allowing the prosthetist to undertake more challenging duties, reducing healthcare costs in terms of chair costs and number of appointments needed, and permitting replacement prostheses to be produced more rapidly and with a short turnaround time.

### SUMMARY OF INVENTION

The present invention relates to two areas of development that are intrinsically linked. Firstly, a custom designed 3D printer with x-y-z gantry robot with an accuracy of 0.1 μm was adapted with a custom designed printing head. Secondly, a two component silicone elastomer suitable for RP was developed that incorporates the desired characteristics and properties similar to those commercially available for the provision of facial and body prostheses. The silicone elastomer is composed of polydimethylsiloxane (PDMS) chains, filler, catalyst and cross-linker By varying the amount of these components the mechanical properties of the silicone elastomer can be altered, for example, tensile strength, tear strength, hardness and wettability. To achieve these desired properties consideration must also be given to the set time and viscosity of the silicone elastomer and additionally the speed at which the material is printed.

A biocompatible pigmented silicone with properties similar to currently used elastomers has been developed and printed. The hardness can be varied between 10-26 Shore A while the tensile strength ranges from 1.1 to 3.3 kN/m. The colour and hardness of 3D printed silicone can be varied through the print process to suit the final application. This technology has the potential to manufacture complex facial/body prostheses of similar characteristics to that of current silicone elastomers used in the traditional way. Further research is needed to ensure appropriate digital colouring of the silicone elastomer to match the patients' natural tissues. Ultimately, this would provide the maxillofacial prosthetist with a tool that manufactures prostheses reliably, with less emphasis placed on individual artistic interpretation.

According to one aspect, the present invention provides a 3D printer that comprises an x-y-z gantry robot that includes a material delivery system comprising a mixing chamber, the mixing chamber further comprising a mixer body, a mixer nozzle and a mixing paddle. The material delivery system further comprises a plurality of syringe pumps connectable to the mixing chamber delivering streams of the constituents of a printing material to the mixing chamber.

The mixing paddle is threaded through the port block into the mixing chamber, and is rotated by means of a motor to mix the printing material prior to its extrusion from the mixer nozzle. The mixing paddle may be a 1/32″ shaft with a machined conical end and milled edges.

In one embodiment, the mixing chamber may have a base diameter of ¼″, and be capable of holding a 300 nL volume of printing material. Preferably, the mixing chamber comprises 2, 3 or 4 micro-machined channels, wherein the constituents of the printing material may be delivered from the syringe pumps to the mixing chamber.

In a further embodiment, the mixer nozzle may have a diameter of about 0.1, preferably up to about 0.5 mm.

According to one embodiment, the plurality of syringe pumps may be capable of exerting a pressure of up to 700 psi in a 3 mL or, alternatively, a 5 mL syringe. The flow rate of material as it is delivered to the mixing chamber is controlled by the plunger speed of the syringe, wherein the plunger speed may be 200 nL per second. Preferably, syringe pumps are connected to a port block surrounding the mixing chamber by means of tubing, wherein the tubing may have a burst pressure of 350 psi. The plurality of syringe pumps may be controlled by servo motors and, in one embodiment, the 3D printer may comprise four syringe pumps. The plurality of syringe pumps may further be coupled to a plurality of linear actuators.

In another embodiment, the 3D printer of the present invention may be used for the printing of a silicone elastomer composition. Preferably, the printing of a silicone elastomer may be used to produce anatomical prostheses.

In a further embodiment of the present invention, the x-y-z gantry robot may have a precision in the x-y plane of about 0.01 μm step resolution and about 0.1 μm repeatability, and a precision of about 0.1 μm, preferably up to about 1 μm in the z plane.

In one embodiment, the printing speed of the 3D printer may be about 10 mm/s, preferably up to about 12 mm/s.

According to a second aspect, the present invention provides a method of printing silicone elastomer compositions with a 3D printer that includes an x-y-z gantry robot. The method comprises receiving the constituents of a silicone elastomer composition from a plurality of syringe pumps, mixing the constituents of the silicone elastomer composition in a mixing chamber by means of a motorised mixing paddle to produce the silicone elastomer material, wherein the mixing chamber further comprises a mixing body and a mixing nozzle, extruding the silicone elastomer composition via the mixing nozzle, and moving the x-y-z gantry robot to form an object with the extruded silicone elastomer composition, wherein the dimensions and shape of the object have been predetermined.

According to a further aspect of the present invention, there is provided a 3D printing system comprising an input device, a 3D printer, a processor, and a computer readable medium. The 3D printer comprises an x-y-z gantry robot that includes a material delivery system comprising a mixing chamber, the mixing chamber further comprising a mixer body, a mixer nozzle and a motorised mixing paddle. The material delivery system further comprises a plurality of syringe pumps connectable to the mixing chamber. The computer readable medium storing one or more machine instruction(s) is arranged that when executed the processor is caused to control the 3D printer to receive the constituents of a silicone elastomer composition from the plurality of syringe pumps, mix the constituents of the silicone elastomer composition in the mixing chamber by means of the motorised mixing paddle to produce the silicone elastomer composition, extruding the silicone elastomer composition via the mixing nozzle, and moving the x-y-z gantry robot to form an object with the extruded silicone elastomer composition, wherein the dimensions and shape of the object have been predetermined.

In one embodiment, the one or more machine instruction(s) include the displacement rate of the plurality of syringe pumps, wherein the processor caused to set the speed of each syringe according to the print pattern requirements.

In a further embodiment, the 3D printing system further comprises a thermoplastic printer that comprises a second printer head having a heating element through which thermoplastic and/or soluble materials are extruded. Preferably, the thermoplastic printer is controlled by a stepper motor, wherein the stepper motor feeds the thermoplastic printing material from a reel into a receptacle within the second printer head. The material printed by the thermoplastic printer is capable of providing a support structure for the printing of the silicone elastomer composition printed by the 3D printer, wherein the silicone elastomer may be used to produce anatomical prostheses. The mixer nozzle of the thermoplastic printer may have a diameter of about 0.1 mm, preferably up to 2 mm. In embodiments of the present invention, the thermoplastic printer may be used individually or in combination with the 3D printer. For example, the 3D printing system may print an object in a plurality of parts, wherein each part is printed in sequence by alternating between the thermoplastic printer and the 3D printer, such that each printed part comprises a support structure and a silicone elastomer composition. In another aspect of the present invention, there is provided a silicone elastomer composition comprising a cross-linked polydimethylsiloxane polymer, wherein the cross-linked polydimethylsiloxane polymer comprises at least two of (a) a low molecular weight polydimethylsiloxane polymer component, (b) a medium molecular weight polydimethylsiloxane polymer component, and (c) a high molecular weight polydimethylsiloxane polymer component.

The term “low molecular weight” as used herein refers to a polymer having a molecular weight of about 1000 to about 12000, preferably about 2000 to about 10000, more preferably about 4000 to about 8000, as measured by a 3D printing system comprising an input device, a 3D printer, a processor, and a computer readable medium. The 3D printer comprises an x-y-z gantry robot that includes a material delivery system comprising a mixing chamber, the mixing chamber further comprising a mixer body, a mixer nozzle and a motorised mixing paddle. The material delivery system further comprises a plurality of syringe pumps connectable to the mixing chamber. The computer readable medium storing one or more machine instruction(s) is arranged that when executed the processor is caused to receive the constituents of a silicone elastomer composition from the plurality of syringe pumps, mix the constituents of the silicone elastomer composition in the mixing chamber by means of the motorised mixing paddle to produce the silicone elastomer composition, extruding the silicone elastomer composition via the mixing nozzle, and moving the x-y-z gantry robot to form an object with the extruded silicone elastomer composition, wherein the dimensions and shape of the object have been predetermined.

The term “medium molecular weight” as used herein refers to a polymer having a molecular weight of about 15000 to about 50000, preferably about 20000 to about 40000, more preferably about 25000 to about 30000, as measured by a 3D printing system comprising an input device, a 3D printer, a processor, and a computer readable medium. The 3D printer comprises an x-y-z gantry robot that includes a material delivery system comprising a mixing chamber, the mixing chamber further comprising a mixer body, a mixer nozzle and a motorised mixing paddle. The material delivery system further comprises a plurality of syringe pumps connectable to the mixing chamber. The computer readable medium storing one or more machine instruction(s) is arranged that when executed the processor is caused to receive the constituents of a silicone elastomer composition from the plurality of syringe pumps, mix the constituents of the silicone elastomer composition in the mixing chamber by means of the motorised mixing paddle to produce the silicone elastomer composition, extruding the silicone elastomer composition via the mixing nozzle, and moving the x-y-z gantry robot to form an object with the extruded silicone elastomer composition, wherein the dimensions and shape of the object have been predetermined.

The term “high molecular weight” as used herein refers to a polymer having a molecular weight of about 80000 to about 150000, preferably about 100000 to about 130000, more preferably about 110000 to about 120000, as measured by a 3D printing system comprising an input device, a 3D printer, a processor, and a computer readable medium. The 3D printer comprises an x-y-z gantry robot that includes a material delivery system comprising a mixing chamber, the mixing chamber further comprising a mixer body, a mixer nozzle and a motorised mixing paddle. The material delivery system further comprises a plurality of syringe pumps connectable to the mixing chamber. The computer readable medium storing one or more machine instruction(s) is arranged that when executed the processor is caused to receive the constituents of a silicone elastomer composition from the plurality of syringe pumps, mix the constituents of the silicone elastomer composition in the mixing chamber by means of the motorised mixing paddle to produce the silicone elastomer composition, extruding the silicone elastomer composition via the mixing nozzle, and moving the x-y-z gantry robot to form an object with the extruded silicone elastomer composition, wherein the dimensions and shape of the object have been predetermined.

In a further aspect of the present invention, there is provided a precursor composition comprising a polydimethylsiloxane base polymer and a cross-linking agent, wherein the polydimethylsiloxane base polymer comprises at least two of (a) a low molecular weight polydimethylsiloxane polymer, (b) a medium molecular weight polydimethylsiloxane polymer, and (c) a high molecular weight polydimethylsiloxane polymer. The composition may further comprise a catalyst.

In a further aspect of the present invention, there is provided a precursor composition comprising a polydimethylsiloxane base polymer and a catalyst, wherein the polydimethylsiloxane base polymer comprises at least two of (a) a low molecular weight polydimethylsiloxane polymer, (b) a medium molecular weight polydimethylsiloxane polymer, and (c) a high molecular weight polydimethylsiloxane polymer.

Preferably, the catalyst is an unmasked platinum catalyst, such as platinum in cyclic methylvinylsiloxane. Furthermore, the polydimethylsiloxane base polymer preferably has vinyl end-blocked chains.

In yet a further aspect of the invention, there is provided an article of manufacture obtainable by the method of printing silicone elastomer compositions with a 3D printer that includes an x-y-z gantry robot. The method comprises receiving the constituents of a silicone elastomer composition from a plurality of syringe pumps, mixing the constituents of the silicone elastomer composition in a mixing chamber by means of a motorised mixing paddle to produce the silicone elastomer material, wherein the mixing chamber further comprises a mixing body and a mixing nozzle, extruding the silicone elastomer composition via the mixing nozzle, and moving the x-y-z gantry robot to form an object with the extruded silicone elastomer composition, wherein the dimensions and shape of the object have been predetermined.

In another aspect of the invention, there is provided an article of manufacture obtainable by mixing at least two of (a) a low molecular weight polydimethylsiloxane polymer, (b) a medium molecular weight polydimethylsiloxane polymer, and (c) a high molecular weight polydimethylsiloxane polymer, with a cross-linking agent, and a catalyst.

In a further aspect of the invention, there is provided an article of manufacture, which is comprised of, at least in part, a cross-linked polydimethylsiloxane polymer, wherein the polydimethylsiloxane base polymer used for the cross-linking reaction is a mixture of at least two of (a) a low molecular weight polydimethylsiloxane polymer, (b) a medium molecular weight polydimethylsiloxane polymer, and (c) a high molecular weight polydimethylsiloxane polymer. In particular, the article may be an anatomical prosthesis, such as a maxillofacial prosthesis.

In another aspect of the invention, there is provided a use of a precursor composition comprising a polydimethylsiloxane base polymer, and optionally a cross-linking agent, in 3-D printing, wherein the polydimethylsiloxane base polymer comprises at least two of a low molecular weight polydimethylsiloxane polymer, a medium molecular weight polydimethylsiloxane polymer, and a high molecular weight polydimethylsiloxane polymer. The composition for use in this manner may further comprise a catalyst.

The amount of low molecular weight polydimethylsiloxane polymer may be in the range of about 10 to about 30 wt % of the total elastomer composition or precursor composition. The amount of medium molecular weight polydimethylsiloxane polymer may be in the range of about 10 to about 30 wt % of the total elastomer composition or precursor composition. The amount of high molecular weight polydimethylsiloxane polymer may be in the range of about 50 to about 70 wt % of the total elastomer composition or precursor composition.

The catalyst used to cross-link the polydimethylsiloxane polymer may be an unmasked platinum catalyst, such as 3-3.5% platinum in cyclic methylvinylsiloxane. The catalyst may be present in about 0.01 to about 0.3 wt %, preferably about 0.05 to about 0.5 wt %, of the total elastomer composition or precursor composition.

The cross-linking agent used to cross-link the polydimethylsiloxane polymer may be present in about 2.5 to about 12.5 wt % of the total elastomer composition or precursor composition. In particular, the cross-linking agent may be a methylhydrosiloxane-dimethyl siloxane copolymer, such as a methylhydrosiloxane-dimethyl siloxane copolymer with a molecular weight of about 2000 and a mole % of methylhydrosiloxane (MeHSiO) of about 25 to about 30.

The silicone elastomer composition and/or the precursor composition may also include a filler, a pigment, a thixotropic agent, and/or a moderator.

The filler may be a silica-based filler, such as methylsilane surface-treated silica. The filler may be present in about 10 to about 30 wt %, preferably about 15 to about 25 wt %, of the total elastomer composition or precursor composition.

The thixotropic agent may be present in up to about 5 wt %, preferably up to about 3 wt %, of the total elastomer composition or precursor composition. The thixotropic agent, when present, has the effect of increasing the viscosity of the silicone components.

The moderator may be present in up to about 1 wt %, preferably up to about 0.5 wt %, of the total elastomer composition or precursor composition. Surprisingly, the use of a moderator was found to be particularly effective in the prevention of dragging, e.g. the premature curing of the silicone elastomer on the tip of the printer and subsequent disfiguration of the printed material. Increasing the concentration of moderator resulted in an increase in the working time of the silicone elastomer.

In a further embodiment of the present invention, the silicone elastomer composition may have a tear strength of about 1.1 kN/m, preferably up to about 9.9 kN/m. The silicone elastomer composition may have a tensile strength of about 0.6 MPa, preferably up to about 3.3 MPa. The silicone elastomer composition may have a hardness of about 6 shore A, preferably up to about 26 shore A.

### BRIEF DESCRIPTION OF DRAWINGS

The present invention will now be described by way of example only, and with reference to the accompanying drawings in which:

FIG. 1 shows an exploded view of the custom designed 3D printing head according to one embodiment of the present invention;

FIG. 2a shows a cross-sectional view of the mixing chamber and mixing nozzle according to one embodiment of the present invention;

FIG. 2b shows a cross-sectional view of the 3D printer head according to one embodiment of the present invention;

FIG. 3 shows a side view of the 3D printer head according to one embodiment of the present invention;

FIG. 4a illustrates the 3D printer head according to one embodiment of the present invention, wherein two syringe pumps are connected to the mixing chamber;

FIG. 4b illustrates the 3D printer according to an embodiment of the present invention including the x-y-z gantry robot, wherein the 3D printer is connected to computer system;

FIG. 5 illustrates an example of a 3D printing system according to an embodiment of the present invention;

FIG. 6 illustrates a further example of a 3D printing system according to an embodiment of the present invention.

FIG. 7a illustrates the 3D printer according to an embodiment of the present invention including the x-y-z gantry robot, wherein the 3D printer is connected to computer system;

FIG. 7b illustrates a thermoplastic printer head according to one embodiment of the present invention;

FIG. 8a illustrates the 3D printer head according to one embodiment of the present invention;

FIG. 8b illustrates the 3D printer head according to one embodiment of the present invention;

FIG. 9 illustrates the mechanical properties of different silicone elastomer compositions with varying cross-linker % according to embodiments of the present invention, as compared with the mechanical properties of commercial silicones;

FIG. 10 illustrates the tear strength of different silicone elastomer compositions according to embodiments of the present invention;

FIG. 11 illustrates the hardness of different silicone elastomer compositions according to embodiments of the present invention;

FIG. 12a shows an example of printed silicone obtained during the development of the present invention;

FIG. 12b shows an example of printed silicone according to embodiments of the present invention;

FIGS. 13a-c illustrate samples of printed silicone used to test the mechanical properties of different silicone elastomer compositions.

### DETAILED DESCRIPTION OF DRAWINGS

The development of this technology was approached in two parts. The first step was to be able to print a suitable material using a rapid prototyping (RP) technique that had the desired characteristics and properties similar to those currently used in the provision of facial and body prostheses, and that simulated skin texture. Once a suitable material was found and used to print an anatomical prostheses, the second step was to reproduce the colour of a patient's skin on the selected material by evaluating various methods of colour printing directly onto the surface of the material or by layering the material during the printing, or by any other suitable method.

Printer Development

For the first part, it was necessary to identify a 3D printer that was capable of printing facial and body silicone prostheses that would be compatible with current facial elastomers. Known 3D printers produced by commercial companies were eliminated as the silicone elastomers that are printable on such printers have a hardness value above the requirement for facial elastomers. Additionally, commercial companies were not willing to invest the time or money needed for the development, and would not allow adaption of their printers to let the required materials to be used.

A printer developed for printing ceramics was identified as potentially viable to achieve both objectives. The printer comprises an x-y-z gantry robot (Aerotech AGS1000 ES16232), a material delivery system, motion control software (Aerotech A3200), and component design software (RoboCAD 4.0). The gantry robot has high precision in the x-y plane (0.01 μm step resolution, 0.1 μm repeatability) and precision in the z plane of around 0.1 to 1 μm. The motion can be accurately controlled at speeds from a few μm per second to many mm per second. Typically, the printing occurs with linear write speeds of 10-12 mm per second.

The material delivery system comprises an array of syringe pumps, for example, an array of five syringe pumps, which deliver material either directly to an array of deposition nozzles or to a mixing chamber with a single nozzle. The nozzle diameter can be selected between 0.1 and 2 mm, but typical nozzles are in the 0.1 to 0.2 mm diameter range. The syringe pumps are positive displacement pumps capable of producing 100 lb of thrust force on the syringe plunger, such that it is capable of creating around 700 psi of pressure in a 3 mL or 5 mL syringe. It may also be possible to use 20 mL syringes. The flow rate is controlled by the plunger speed, and is usually around 2 nL per second. Where a mixing chamber with a single nozzle is used, the mixing chamber consists of a ¼″ base-diameter, inverted, truncated cone core with micro-machined channels on the surface to allow the convergence of two, three or four streams of material at the apex of the cone. The chamber is formed when a mating cone shaped tip with a stainless steel capillary tube is pressed against this core to create a mixed volume on the order of 300 nL. Mixing is then accomplished with a 1/32″ diameter shaft on the centre-line of the cone that has a machined paddle at the end. This shaft is rotated by a motor and blends the material streams prior to extrusion.

Printer and Material Familiarisation Period

Initially, printer training and experimentation with some different formulations of silicone elastomers was conducted. Single component, moisture cure, RTV silicone had previously been shown viable, but further evaluation was performed relating to the use of the mixing chamber to determine the parameter space (i.e., catalyst, accelerator, thixotropic agent concentrations) that would enable reliable flow of material as well as good shape retention.

Although two-component silicones were successfully printed at this stage, several challenges were identified and many remedied prior to converging on a final design for the mixing chamber and an understanding of the requirements for a suitable silicone elastomer formulation for printing.

Leakage Issue

The initial mixing chamber was constructed of plastic components for all the wetted parts (save the mixing paddle itself) as well as the threads for connection of material delivery tubing to the chamber and affixation of the cone-shaped printing tip. These had been designed for assembly with no-tooling. However, due to the high viscosity of silicones and weak joints, seals on moving parts leaked. The mixing chamber was therefore re-designed to maintain plastic wetted parts, but the mechanical joints were machined from aluminium. The hand assembly scheme was abandoned in favour of the use of spanner wrenches to ensure that joints were tight and did not leak. Additionally, better seals around the mixing paddle consisting of a PTFE ferrule and a silicone O-ring sealed the mixing shaft and improved stability of the mixing paddle. Nylon tubing with a burst rating of 350 psi was substituted for poly propylene tubing with a 180 psi rating to deliver the silicone components from the syringe pumps to the mixing chamber.

Non-Curing

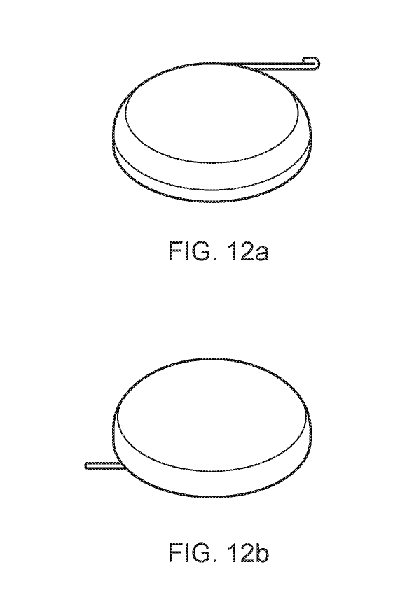

A second material problem occurred in that the silicone would not cure after printing, as exemplified by FIG. 12a. There are different types of silicone, some of which do not require mixing and heat applied to act as a catalyst. After trying various combinations of silicones it was decided that room temperature vulcanising (RTV) two-component silicones were best suited for the purpose. One part contains the base silicone and crosslinking agent and the other contains a base and a catalyst. These require proper mixing of both parts to cure fully. After successfully printing two component silicones the major hurdle was overcome, although this product was still not adequate as the printed silicone would not cure even if left for longer intervals. A solution was identified by increasing the mixing paddle speed/torque. This enabled adequate mixing of the two components so that a full cure was achieved, as shown in FIG. 12b.

Structural

The third challenge to overcome was the initial loss of printing improper shapes which would not retain their shape. As the height of product increased the lower layers would not hold their shape and flow. This eventually led to irregular uneven top layers as the base below them moves and becomes uneven. This issue was tackled by increasing the viscosity of silicone components by including thixotropic agents to the silicone precursor composition. High viscosity ensures that the shape is retained and does not flow. Increased viscosity increases the pressure inside the system to make it flow.

Wear of Mixing Shaft

A fourth issue to overcome was prevention of damage to the mixing shaft that was observed. As the shaft rotated at high speed it would rub against the metal and plastic parts that are in contact. The plastic parts do not cause much damage but the metals rubbing against each other led to wear of the shaft. Therefore the design was altered to avoid contact between the moving parts. The shaft cylinder is kept at a distance from the shaft by tiny pieces of plastic or O-rings in between.

Dragging

Dragging initially occurred with larger printed test samples as the samples take longer to print and the printing tip is in contact with the sample for longer. The silicone starts curing from the time when two components come together in the mixing chamber. When printing is initiated, silicone lines the surface inside the mixing chamber and tip as well as outside the tip which remains in contact with the sample. As time passed the silicone on the outer surface of the tip cured, which led to formation of a lump on the outer edge of the printing tip. When printing larger parts this lump disturbed the printing of further layers as a tail of cured silicone followed the tip. This resulted in uneven printing. Two-component RTV's silicones have a short working time and to increase the working time, a moderator may be incorporated. To overcome the dragging issue the moderator concentration was increased to achieve working times longer than the print time. This makes sure that no silicone cures before the print is completed.

Material Development

Twenty different compositions of silicone were initially selected as a basis for the development of a novel silicone system for 3D printing. The curing assessment was performed on all samples and this provided the vital data regarding the working time and curing time. Initially a heat cure addition system was used to obtain preliminary data on the working time and set times to provide an idea of what combination of silicone base material, catalyst, cross-linker and filler would possibly print. However, realistically it was known that it would not be possible to use a heat cured silicone for printing as there would be no way to cure the silicone. However, with a Room Temperature Vulcanising (RTV) system, using an unmasked platinum catalyst could be used allowing a rapid cure without the application of heat.

A curing assessment was performed on each composition to provide vital data on working time and curing time. The cross-linker used in all formulations was MethylHydrosiloxane-Dimethylsiloxane Copolymer with a molecular weight of 2000 and a mole % of MeHSiO of 25-30. The results for the preliminary silicone showed that increasing the cross-linker concentration decreased the working time for all types of base polymers. A high degree of cross-linking gives a very inelastic polymer while low cross-linking gives a very weak material which is related to its tear and tensile strength. This was born out in the mechanical results obtained for the different formulations.

The base polymers selected were made up of high-, medium- and low molecular weight vinyl end blocked chains. More specifically the long chained polymer had a molecular weight of 117,000, the medium chain 28,000 and the short chain 6000. Blending these polymers in specific ratios has an effect on the mechanical (tensile, tear strength, hardness and wettability) properties of the resulting elastomer. The mixture of high molecular weight chains and short chains gives a broader bimodal network. This helps in designing elastomers with good combination of tear strength, tensile behaviour and resilience. In all polymeric blends a methylsilane surface treated silica filler was used, at a specific loading of 20% w/w filler and 80% PDMS chain which was kept constant for all formulations.

The mechanical properties of the printed samples may be determined which assist in selection of appropriate material for facial prosthesis fabrication. Tear and tensile tests carried out on some of the samples showed that their properties are comparable to some currently used elastomers. Further to this, the sample with the highest tear strength was found to be considerably more than that of commercial silicones. The mechanical properties of commercial silicones, for example, Techsil (S25), Cosmesil (M511) and Cosmesil (Z004), are such that as the cross-linker concentration increases the tear strength also increases initially and then starts to drop after reaching peak value.

Further Development

The 3D printer is capable of efficiently printing two component RTV silicone elastomers in various shapes and different heights without leakage. At present, more development is required to the control software in order to print more complex shapes. Additionally, various pigments to create different ethnic skin colours have been placed into both the base and catalyst syringes which feed into the mixer to ensure that the print head can take the pigment particle size. Further to this, wool fibres to simulate blood vessels in skin have been fed into these base colours and printed as samples. This process needs further experimentation as the wool fibres sometimes collect in the mixing chamber.

The next step in development will be to assess the best way of printing silicone to reproduce skin colour and texture. It is felt that two approaches would be of benefit: 1) a layering approach i.e. a layer of colour and a layer of translucent silicone on an alternative basis; and 2) printing a solid colour of appropriate translucency. The last step in development will be to create a support material for complex and challenging shapes, including actual facial and body parts.

3D Printer Design

Initially, the mixing chamber was a single piece of Delrin with ¼-28 female ports for tube connections. The main advantage of this uni-body construction was that no leaks occurred, however, this arrangement was very difficult to both manufacture and clean, and check valves were not readily available. The primary difficulty was the need to create a 90° bend at one end of the drilled holes to accommodate threaded ports. This meant drilling long, blind holes of very small diameter.

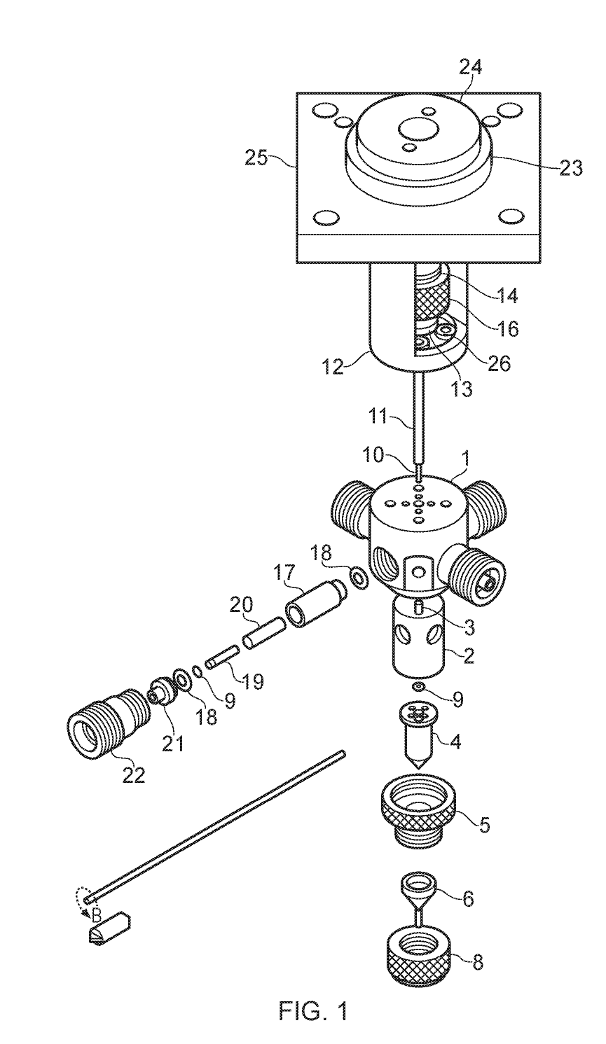

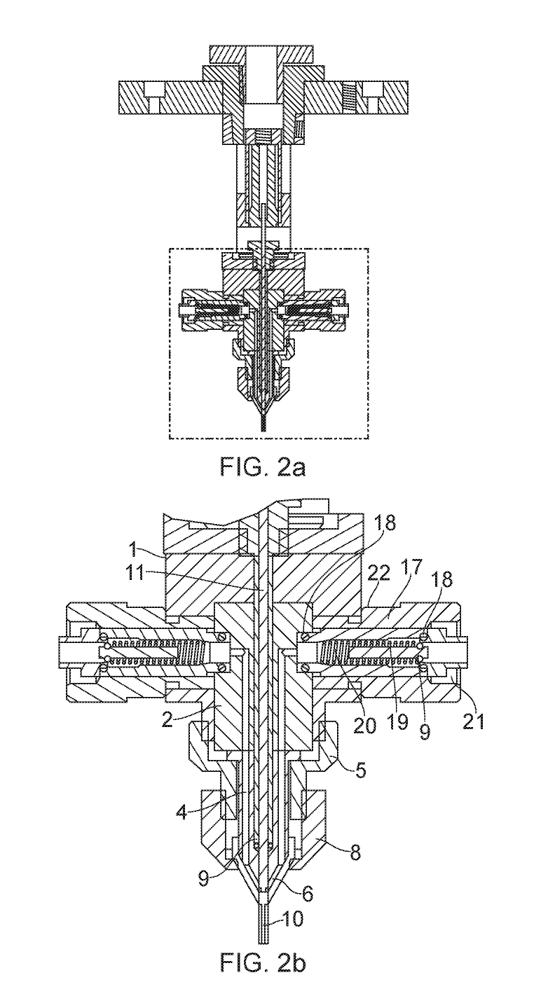

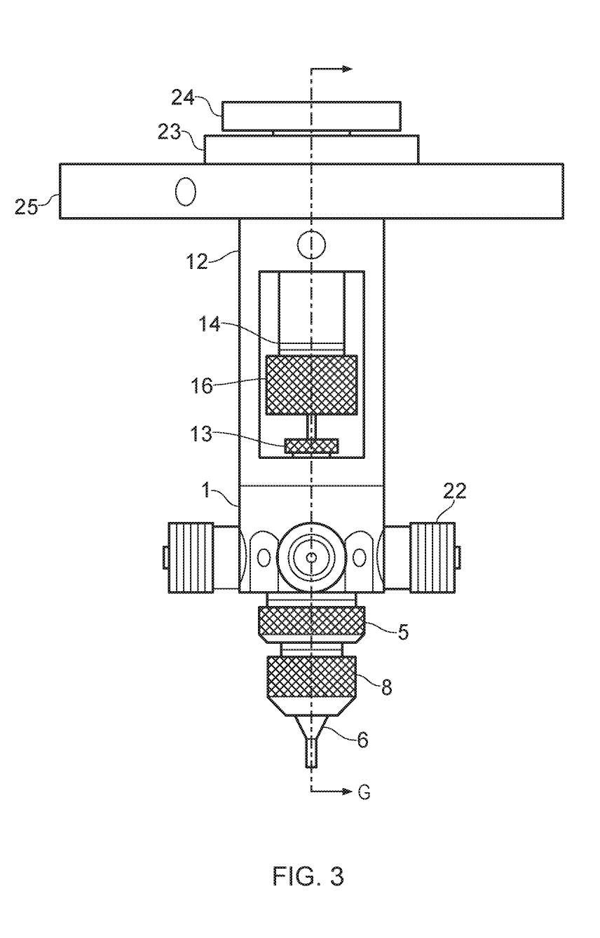

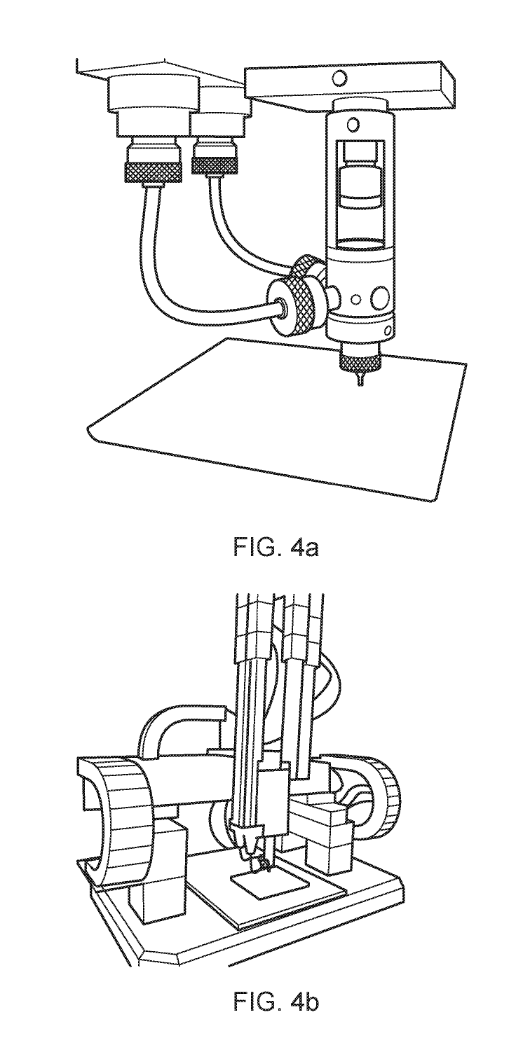

The custom designed 3D printer used for this invention, as shown by FIGS. 4a and 4b, comprises an x-y-z gantry robot with an accuracy of 0.1 μm across the range of travel in coordinated linear motion, adapted with a custom designed printing head. This custom designed printing head, as illustrated by FIGS. 1 to 3 with reference to Table 2, is a modular design comprising a port block 1, a port insert 2, and a mixing chamber that is formed by three components; a mixing nozzle 6, a mixer body 4, and a mixing paddle 10. The mixer body 4 has four 1 mm diameter channels drilled through parallel to the main axis, but offset from the central axis. The mixing nozzle 6 seals with the mixer body 4 on a conical surface (60° cone angle). On the surface of the mixer body cone 4 are channels with a 1 mm×1 mm cross section. The drilled channels and channels on the surface of the mixer body cone 4 provide the flow path to direct the components of the silicone precursor composition to the mixing nozzle 6.

The port insert 2 has four channels, drilled equiangularly around the port insert 2, that are shorter in length and have a 90° bend at the top end to connect to the silicone streams from an array of syringe pumps via a check valve assembly. The port block 1 has four ports arranged laterally to the four channels of the port insert 2, each of which includes a custom check valve assembly. The check valve assembly consists of a body A 17, wherein first lies an O-ring 18, followed by a spring 20, and a pin 19. This is proceeded by a second smaller O-ring 9, a third O-ring 18, and finally a body B 21 cushioned against the third O-ring 18. This check valve assembly is housed within each port insert 2 and kept tight by a port adapter 22.

The mixer body 4 is mated to the port insert 2 by a flange joint 9 and the drilled channels in the mixer body 4 are aligned with the drilled channels of the port insert by a locater pin 3. The flange joint 9 arranged between the mixing chamber 4 and port insert 2 may be kept tight by nuts 5 and 8 which are positioned at the bottom end of the mixing chamber arrangement. This modular design allows for a variety of mixer bodies that have two, three, or four drilled channels and further channels on the cone surface. The mixer body 4, mixing nozzle 6, and mixing paddle 10 are capable of containing a volume of approximately 300 nL wherein a volume of silicone elastomer composition may be stirred by the rotating mixing paddle 10. The mixing paddle 10 is threaded down the centre line of the printer head through shaft tube 11, and may comprise of a stainless steel shaft with a machined end that matches the interior shape of the mixing nozzle 6 (i.e., a conical shape). The mixing paddle 10 is rotated by an electric motor that is affixed with mechanical elements of a stand-off 12 (rigid mechanical frame), and a collet assembly consisting of a collet holder 14, a collet 15, and a collet nut 16. The electric motor is held by a first and second motor mount part 23, 24 and affixed to the 3D printer with a mounting plate 25.

Preferably, all of the wetted components are made of either Delrin, PEEK or stainless steel. Preferably, all threaded parts are made of metal.

The silicone elastomer precursor composition, or constituent materials thereof, may be delivered to the mixing chamber via an array of syringe pumps 51c, as shown by FIGS. 4a-b and 5, which are connected to the printing head via tubing that is attached to each port of the port block 2. The syringe pumps 51c are capable of generating 100 lb of thrust, which is equivalent to a syringe pressure of approximately 700 psi in a 9.5 mm diameter syringe. Varying the plunger speed of the various syringes can alter the ratio of silicone elastomer components delivered to the mixing chamber assembly. The tubing between the syringe and check valve assemblies has a burst pressure of 350 psi and is designed to be the weak link in the system in the event that the mixing nozzle 6 should become clogged. All parts of the printer may be easily cleaned using acetone. In some embodiments, the printer head may supplied by four syringe pumps 51c which are controlled by servo motors and enables the two-component silicone to be printed.

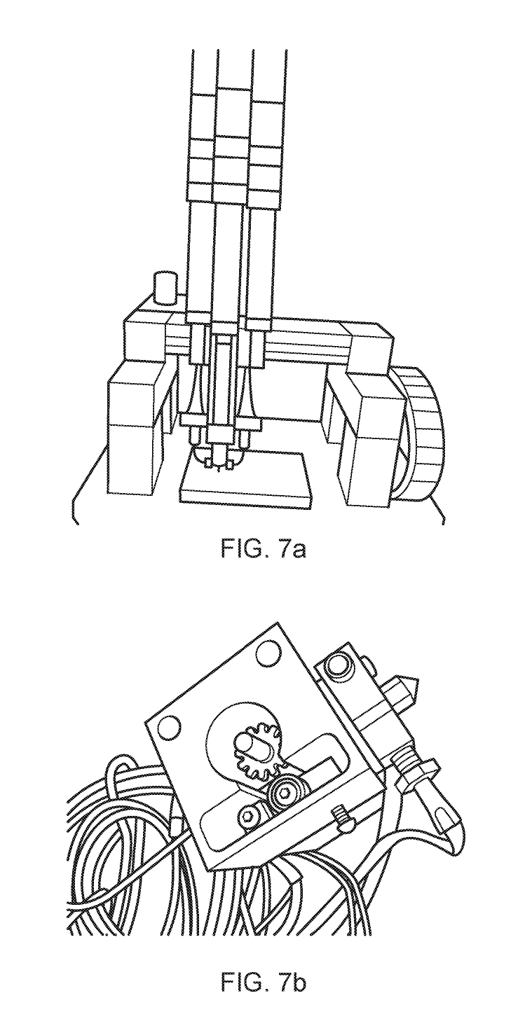

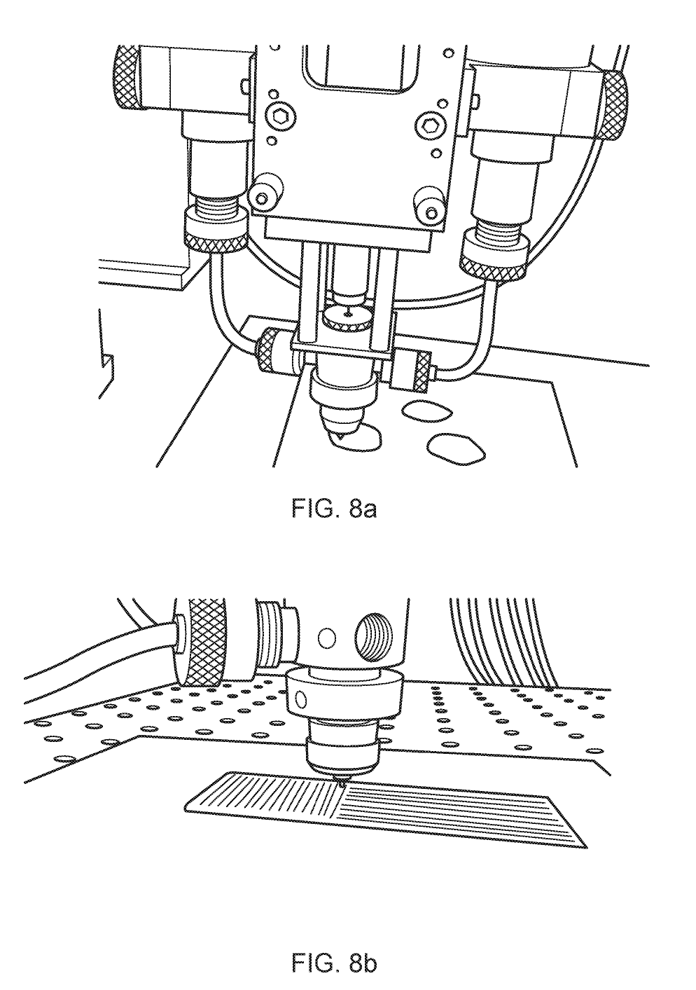

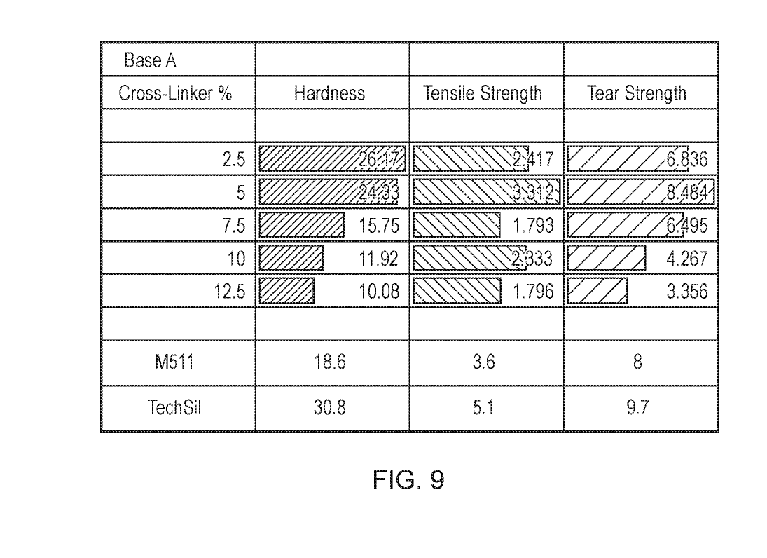

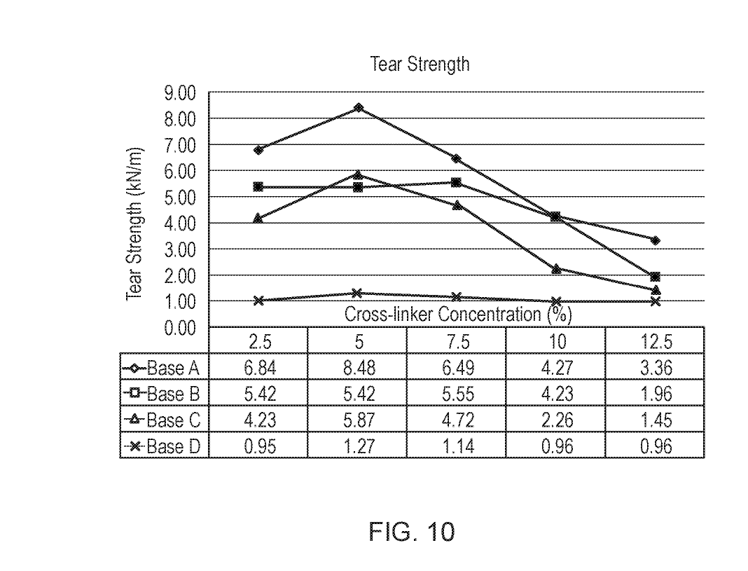

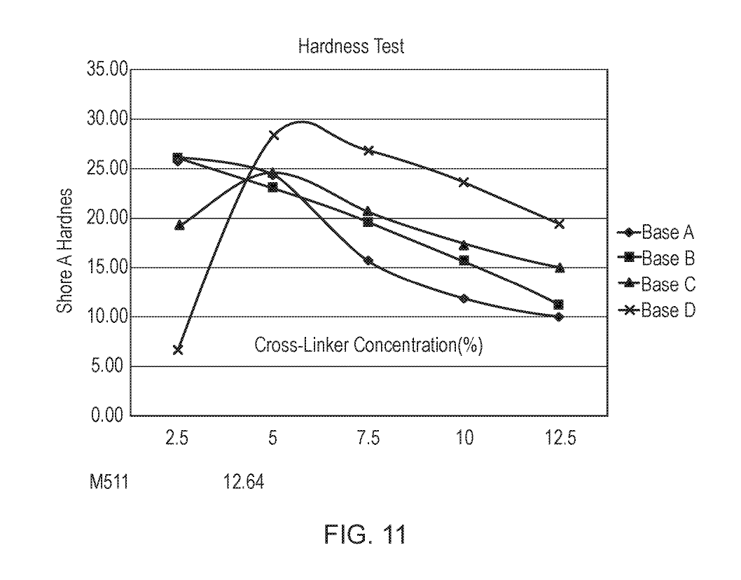

A second printer head shown by way of example in FIG. 7b may also be used, individually or in combination with the 3D printer head. The second printer had includes a heating element that is controlled by a stepper motor and which is used to enable thermoplastic and soluble materials to be printed. This material acts as the support structure for complex printing of three dimensional shapes in silicone. For example, a 3D object may be printed in a number of portions or slices, wherein each portion or slice is printed by first printing a support structure made of the thermoplastic material with the second printer head, and then printing the portion or slice of the 3D object with the 3D printer, this process being repeated until the entire 3D object has been printed. The nozzle diameter of the second printer can be selected between 0.1 mm to 2 mm.

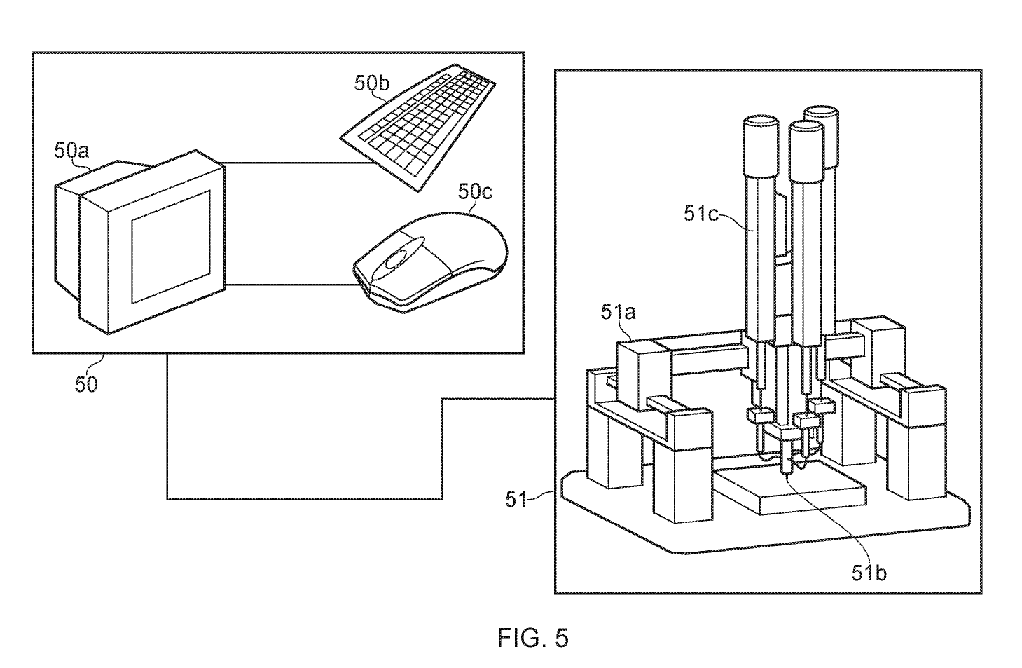

As shown in FIG. 5, the 3D printer assembly 51 is connected to a computer system 50, wherein the computer system may include a computer monitor 50a, and input devices such as a keyboard 50b, computer mouse 50c, or any other controller capable of providing user inputs. The computer system 50 may include motion control software to control the movement of the x-y-z gantry robot 51a, wherein the software may be used to generate computer numerical control (CNC) instructions defining the pattern to be traced by the mixing nozzle 6 of the printer head 51b as it deposits the extruded silicone elastomer composition. The flow rates of the silicone components from the syringe pumps 51c may also be computed to deliver a total volumetric flow rate equivalent to the mixing nozzle 6 internal cross sectional area times the linear write speed. The user may simply design the geometry desired within the software and the tool path is generated automatically as are instructions to initiate, maintain, and terminate flow of the silicone in coordination with the printer motion.

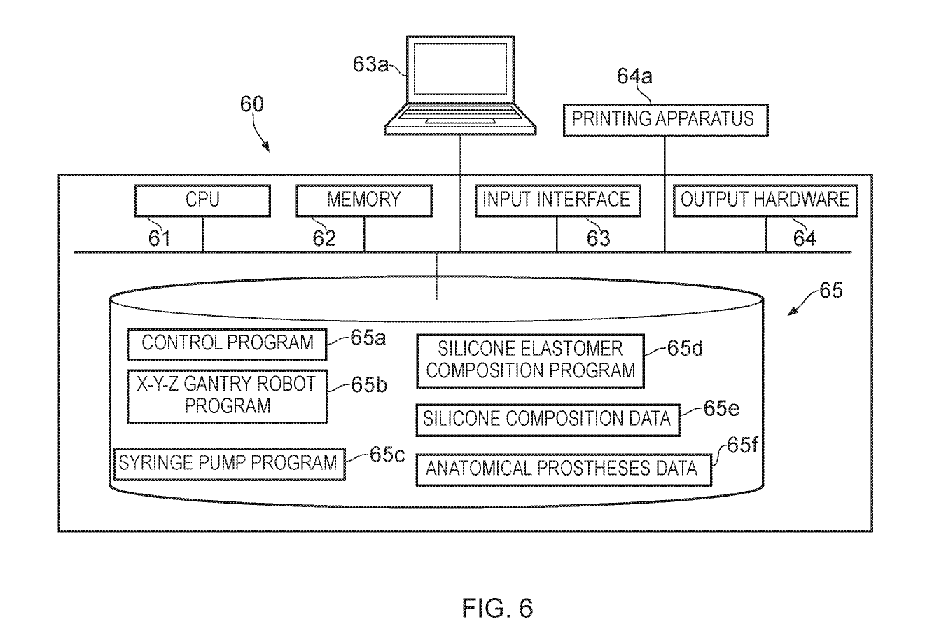

FIG. 6 illustrates a further example of a general computer system 60 that may form the platform for embodiments of the invention. The computer system 60 comprises a central processing unit (CPU) 61, a working memory 62, an input interface 63 arranged to receive control inputs from a user via an input device 63a such as a keyboard, mouse, or other controller, and output hardware 64 arranged to operate based on the output information from the computer system 60. The output hardware 64 includes the 3D printer apparatus 64a as described above.

The computer system 60 is also provided with a computer readable storage medium 65 such as hard disk drive (HDD), flash drive, solid state drive, or any other form of general purpose data storage, upon which stored data 65e, 65f and various control programs are arranged to control the computer system 60 to operate in accordance with embodiments of the present invention. For example, a control program 65a is provided and arranged to provide overall control of the system to perform the embodiments of the present invention. This control program 65a may, for example, receive user inputs and launch other programs to perform specific tasks. The other programs under the control of the control program 65a may include an x-y-z gantry robot program 65b which is arranged to control the movement of the x-y-z gantry robot 51a and a syringe pump program 65c which is arranged to control the pressure exerted by the syringe pumps 51c.

For example, the syringe pump program 65c may be arranged to control the dispensing of the silicone components by programming the displacement rate of the syringe pumps 51c (ram) which are connected to linear actuators (not shown). The total volumetric flow rate, Qₜₒₜₐₗ, of the silicone mixture is thus equal to the write speed, WS, of the printer head 51b times the cross-sectional area of the deposition nozzle 6 (π/4d²), wherein d is the diameter of the nozzle 6. For each syringe that feeds the mixing chamber 4, the fraction of this total flow rate, Fᵢ, is decided based on the reaction chemistry of the silicone components and/or the desired colour of the silicone anatomical prostheses. Hence, the speed for any individual syringe pump 51c (PSᵢ) is the fractional volumetric flow rate (Fᵢ×Qₜₒₜₐₗ) divided by the cross-sectional area of the individual syringe (π/4Dᵢ²), wherein Dᵢ is the diameter of the individual syringe. Therefore, it follows that:

$${PS}_{i} = {F}_{i} {WS ( \frac{{D}_{i}}{d} )}^{2} \qquad ( 1 )$$

Since the diameter of the syringes is known during the planning of the motion path, the software (for example, the syringe pump program 65c) is able to automatically set the speed of each syringe according to the print pattern requirements.

The readable storage medium 65 may further comprise a silicone elastomer composition program 65d which is arranged to monitor and control the ratio of silicone elastomer components delivered to the mixing chamber assembly. Silicone composition data 65e is stored in the readable to storage medium 65 which provides the syringe pump program 65c and silicone elastomer composition program 65d with data relating to the silicone elastomer component ratios required in order to print various materials with different mechanical properties. Additionally, the readable storage medium 65 may also store anatomical prostheses data 65f containing information pertaining to the silicone compositions and printing patterns required for different anatomical prostheses.

It should be appreciated that various other components and systems would of course be known to the person skilled in the art to permit the computer system 60 to operate.

Silicone Elastomer Material

The silicone is composed of polydimethylsiloxane (PDMS) chains, filler, catalyst and cross-linker By varying the amount of these components the mechanical properties of the silicone elastomer can be altered, for example, tensile strength, tear strength, hardness and wettability. In general, silicone elastomers can be classified into two major categories depending on the curing or setting reaction of cross-linker with PDMS chains, either heat vulcanizing or room temperature vulcanizing. For heat vulcanizing silicones, the ingredients are heated so as to activate catalyst/cross-linker to form an elastomer, whilst for room temperature vulcanizing (RTV) external heating is not required. Depending on the catalyst, RTV silicones can be divided into two types, two component and one component RTVs. Two component RTVs is so called because the ingredients are divided into two parts, the cross-linker is stored separately from the rest of recipe until the final curing step is needed. As the cross-linker comes into contact with the rest of the recipe it commences polymerisation. One component RTVs are kept in sealed containers as exposure to moisture in the air causes vulcanisation.

Realistically it is known to not be possible to use a heat cured silicone for printing as there is no way to cure the silicone. However, with a Room Temperature Vulcanising (RTV) system using an unmasked platinum catalyst may allow a rapid cure without the application of heat. One component RTV silicone can already be 3D printed but is not biocompatible, and thus two component RTV are preferable as its properties are more suitable, that is, they are biocompatible.

The base polymers selected are made up of high-, medium- and low molecular weight vinyl end blocked chains. More specifically the long chained polymer has a molecular weight of 117,000 the medium chain 28,000 and the short chain 6000. Blending these polymers in specific ratios has an effect on the mechanical properties (tensile, tear strength, hardness and wettability) of the resulting elastomer. The mixture of high molecular weight chains and short chains gives a broader bimodal network. This helps in designing elastomers with good combination of tear strength, tensile behaviour and resilience. In all polymeric blends, a methylsilane surface treated silica filler may be used at a specific loading of 20% w/w which may be kept constant for all formulations.

In this system, the components of silicone are separated into two components keeping the reactive agents (i.e. the catalyst and cross-linker) as separate components, while the rest of the constituents (PDMS base polymers, filler, moderator, thixotropic agent, etc.) can be placed in either one or both of the two components.

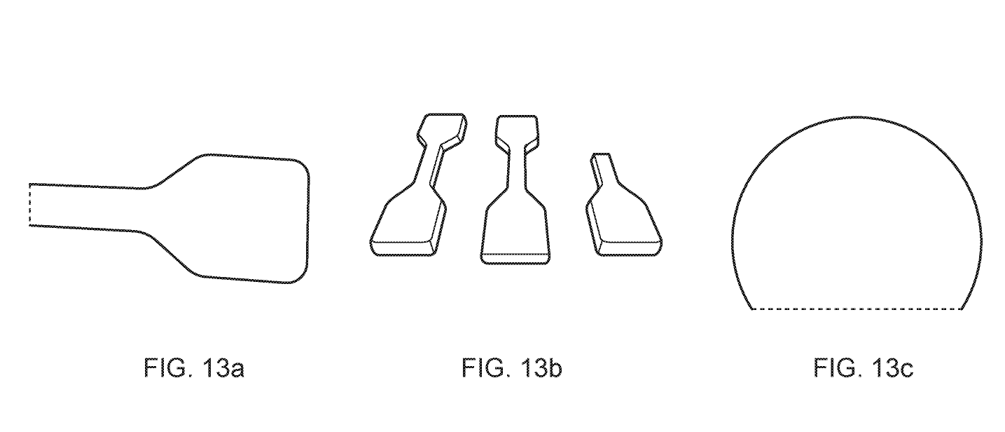

Various concentration combinations of all the constituents may be selected for curing time assessment which provides vital data on working time and curing time. Mechanical testing for hardness, tensile and tear strength was also performed using the silicone samples shown in FIGS. 13a-c for characterization of silicone. The cross-linker used in all formulations is MethylHydrosiloxane-Dimethylsiloxane Copolymer with a molecular weight of 2000 and a mole % of MeHSiO of 25-30. The results for the preliminary silicone show that increasing the cross-linker concentration decreases the working time for all types of base polymers. A high degree of cross-linking gives a very inelastic polymer while low cross-linking will give a very weak material which is related to its tear and tensile strength. The catalyst used is 3-3.5% platinum in cyclic methylvinylsiloxane.

Various combinations of the constituents have been printed with varying mechanical properties so that as an object is being printed, the silicone elastomer composition may be varied such that the mechanical properties of the material being printed correspond to that of the object. In doing this, the printer is able to print realistic anatomical prostheses, which do not have the same properties throughout. For example, a nose is made up of a number of different materials such as tissue, bone and cartilage which do not all have the same mechanical properties. In addition to varying the constituent composition variable printing speeds may be used (approximately 10-12 mm/s).

The mechanical properties are affected by the PDMS chains and cross-linker concentrations, while catalyst concentration only affects the curing rate. The molecular weight of PDMS chains affects properties of the resulting silicone composition. Three types of PDMS chains form the base, high molecular weight PDMS chains (V46) (X), medium molecular weight chains (V31)(Y) and low molecular weight PDMS chains (V21)(Z). By way of example, these may be used to prepare four compositions of base polymer:

Base A=70% X+20% Y+10% Z

Base B=60% X+30% Y+10% Z

Base C=60% X+20% Y+20% Z

Base D=50% X+20% Y+30% Z

These base polymers may then be mixed with varying concentrations of cross-linker from about 2.5% up to about 12.5%, as demonstrated in Table 1 below.

TABLE 1

| Sample No. | Base % | Cross-linker % | Catalyst % |
|---|---|---|---|
| 1 | 95 | 2.5 | 2.5 |
| 2 | 92.5 | 5 | 2.5 |
| 3 | 90 | 7.5 | 2.5 |
| 4 | 87.5 | 10 | 2.5 |
| 5 | 85 | 12.5 | 2.5 |

The working time of the heat cure system is very high (minutes to hours), whilst for RTV it is less than a minute. Due to this, it is difficult to work with RTV and thus mechanical tests may be undertaken with a heat cure catalyst.

The mechanical properties of the various compositions may include a tear strength of 1.1 to 9.9 kN/m, a tensile strength of 0.6 to 3.3 MPa, and a hardness of 6 to 26 shore A. These ranges allow a composition with desired mechanical strength to be chosen for any particular final application. Consider, for example, the 3D printer is being used to print a prosthetic ear, wherein the ear lobe may be printed with a very low hardness whilst the cartilage may be printed with greater hardness by varying the silicone elastomer composition.

Various modifications, whether by way of addition, deletion or substitution may be made to the above described embodiments to provide further embodiments, any and all of which are intended to be encompassed by the appended claims.

### REFERENCE NUMERALS

TABLE 2

| ITEM | QUANTITY | PART | DESCRIPTION |
|---|---|---|---|
| 1 | 1 | Port Block | Aluminium |
| 2 | 1 | Port Block Insert | Delrin |
| 3 | 1 | Locater Pen | 316 stainless steel |
| 4 | 1 | Mixer Body | Delrin |
| 5 | 1 | Mixer Body Nut | Aluminium |
| 6 | 1 | Mixer Nozzle Body | PEEK |
| 7 | 1 | Mixer Nozzle Tube | 316 stainless steel |
| 8 | 1 | Mixer Nozzle Nut | Aluminium |
| 9 | 5 | O-Ring 001 | Silicone (seals mixing |
| | | | paddle) |
| 10 | 1 | Mixing Paddle | 316 stainless steel |
| 11 | 1 | Shaft Tube | 316 stainless steel |
| 12 | 1 | Stand-off | Aluminium |
| 13 | 1 | Shaft Tube Keeper | Brass |
| 14 | 1 | Collet Holder | Aluminium |
| 15 | 1 | Collet | 1/32″ DA-300 Erickson |
| 16 | 1 | Collet Nut | Aluminium |
| 17 | 4 | Body A | Delrin (check value) |
| 18 | 8 | O-Ring 1-3 mm | Silicone (check value) |
| 19 | 4 | Pin | 316 stainless steel |
| 20 | 4 | Spring | 18-8 stainless steel |
| 21 | 4 | Body B | Delrin (check value) |
| 22 | 4 | Port Adapter | Aluminium |
| 23 | 1 | Motor Mount Part 1 | Aluminium |
| 24 | 1 | Motor Mount Part 2 | Aluminium |
| 25 | 1 | Mounting Plate | Aluminium |
| 26 | 4 | 6-32 Undercut | 18-8 stainless steel |

### REFERENCES

[1] Coward, T. J., Watson, R. M., The application of laser scanning and CAD/CAM systems in the fabrication of auricular prostheses, Quintessence Dent. Technol., 1997, 20:47-54
[2] Chen, L. H., Tsutumi, S., Iizuka, T., A CAD/CAM techniques for fabricating facial prostheses: a preliminary report, Int J Prosthodont, 1997 September-October, 10(5):467-472
[3] Coward, T. J., Watson, R. M., Wilkinson, I. C., Fabrication of a wax ear by rapid process modelling using stereolithography, Int. J. Prosthet., 1999, 12(1):20-27
[4] Wolfaardt, J., Sugar, A., and Wilkes, G., Advanced technology and the future of facial prosthetics in head and neck reconstruction, Int. J. Oral Maxillofac. Surg., 2003, 32(2): 121-123
[5] Ciocca, L. and Scotti, R., CAD-CAM generated ear cast by means of a laser scanner and rapid prototyping machine, J. Prosthet. Dent., 2004, 92(6):591-595
[6] Winder, J., and Bibb, R., Medical rapid prototyping technologies: state of the art and current limitations for application in oral and maxillofacial surgery, J. Oral Maxillofac. Surg., 2005, 63(7):1006-1015
[7] Van Noort, R., The future of dental devices is digital, Dent. Mater., 2012, 28(1):3-12

1. A 3D printer comprising an x-y-z gantry robot including a material delivery system, the material delivery system comprising:
a mixing chamber, wherein the mixing chamber comprises:
a mixer body;
a mixer nozzle; and
a mixing paddle;
a plurality of pumps connectable to the mixing chamber for delivering streams of the constituents of a printing material to the mixing chamber,
wherein the mixing paddle is rotated by means of a motor to mix the printing material prior to its extrusion from the mixer nozzle.

2. A 3D printer according to claim 1, wherein the mixing paddle comprises a shaft with a conical end.

3. A 3D printer according to claim 1, wherein the mixing chamber is arranged in use to hold up to around 300 nL volume of printing material.

4. A 3D printer according to claim 1, wherein the mixing chamber comprises 2 or more channels through which the constituents of the printing material are delivered from the pumps to the mixing chamber.

5. A 3D printer according to claim 1, wherein the mixer nozzle has a diameter of up to 0.5 mm, preferably a diameter of about 0.1 mm.

6. A 3D printer according to claim 1, wherein the plurality of pumps are arranged in use to exert a pressure of up to about 700 psi.

7. (canceled)

8. A 3D printer according to claim 1, wherein the pumps are connected to a port block surrounding the mixing chamber by means of tubing, wherein optionally the tubing has a burst pressure of up to about 350 psi.

9. A 3D printer according to claim 1, further comprising a plurality of servo motors for controlling the plurality of pumps.

10. A 3D printer according to claim 1, wherein the plurality of pumps includes up to about four pumps.

11. A 3D printer according to claim 1, further comprising a plurality of linear actuators coupled to the plurality of pumps.

12. A 3D printer according to claim 1, wherein the printing material is a silicone elastomer composition.

13. (canceled)

14. A 3D printer according to claim 1, wherein the x-y-z gantry robot has a precision in the x-y plane of about 0.01 μm step resolution and about 0.1 μm repeatability, and a precision of up to about 1 μm, preferably about 0.1 μm, in the z plane and/or wherein the printing speed of the 3D printer is up to about 12 mm/s, preferably about 10 mm/s.

15. (canceled)

16. A method of printing silicone elastomer compositions using a 3D printer having an x-y-z gantry robot, the method comprising:
receiving the constituents of a silicone elastomer composition from a plurality of pumps;
mixing the constituents of the silicone elastomer composition in a mixing chamber by means of a motorised mixing paddle to produce the silicone elastomer material, wherein the mixing chamber further comprises a mixing body and a mixing nozzle;
extruding the silicone elastomer composition via the mixing nozzle, and moving the x-y-z gantry robot to form an object with the extruded silicone elastomer composition, wherein the dimensions and shape of the object have been predetermined.

17. A 3D printing system comprising:
an input device;
a 3D printer comprising an x-y-z gantry robot including a material delivery system, the material delivery system comprising:
a mixing chamber, wherein the mixing chamber comprises a mixer body, a mixer nozzle and a motorised mixing paddle; and
a plurality of pumps connectable to the mixing chamber;
a processor; and
a computer readable medium storing one or more machine instruction(s) arranged such that when executed the processor is caused to control the 3D printer to:
(i) receive the constituents of a silicone elastomer composition from the plurality of pumps;
(ii) mix the constituents of the silicone elastomer composition in the mixing chamber by means of the motorised mixing paddle to produce the silicone elastomer composition;
(iii) extrude the silicone elastomer composition via the mixing nozzle; and
(iv) move the x-y-z gantry robot to form an object with the extruded silicone elastomer composition, wherein the dimensions and shape of the object have been predetermined.

18. A 3D printing system according to claim 17, wherein the silicone elastomer composition is used to produce anatomical prostheses.

19. (canceled)

20. A 3D printing system according to claim 17, wherein the system further comprises a thermoplastic printer comprising a printer head having a heating element through which thermoplastic and/or soluble materials are extruded.

21. A 3D printing system according to claim 20, wherein the thermoplastic printer is controlled by a stepper motor, wherein the stepper motor is arranged to feed the thermoplastic printing material from a reel into a receptacle within the printer head.

22. A 3D printing system according to claim 20, wherein the material printed by the thermoplastic printer provides a support structure for the printing of the silicone elastomer composition printed by the 3D printer.

23. A 3D printing system according to claim 20, wherein the thermoplastic printer comprises a mixer nozzle having a diameter of up to about 2 mm, preferably about 0.1 mm.

24. A 3D printing system according to claim 20, wherein the 3D printing system prints an object in a plurality of parts, wherein optionally each part is printed in sequence alternating between the thermoplastic printer and the 3D printer, such that each printed part comprises a support structure and a silicone elastomer composition.

25-53. (canceled)
